(19) United States
(12) Patent Application Publication
(10) Pub. No.: US 2009/0055346 A1
(43) Pub. Date: Feb. 26, 2009

(54) Scalable Ticket Generation in a Database System

(75) Inventors: Ryo Chijiiwa, Cerritos, CA (US); Felix Zodak Lee, Portland, OR (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/844,292

(22) Filed: Aug. 23, 2007

(51) Int. Cl. G06F 17/30

(52) U.S. Cl. 707/1

(57) ABSTRACT

Particular embodiments of the present invention are related to a database system with reliable ticket generation functionality. In particular implementations, a method includes selecting, responsive to a request, a ticket bucket, wherein the ticket bucket comprises a current ticket number and a maximum ticket number; obtaining a ticket number based on the current ticket number of the selected ticket bucket and the current generation identifier; conditionally resetting the current and maximum ticket numbers of the selected ticket bucket, if the ticket number exceeds a maximum ticket number of the selected bucket; and returning the ticket number in response to the request if the ticket number exceeds a maximum ticket number of the selected bucket.

### TECHNICAL FIELD

The present disclosure generally relates to database systems and, more, particularly, to a scalable mechanism for generating tickets that uniquely identify database transactions.

### BACKGROUND

Interactive systems connected by wide area networks such as the Internet have steadily evolved into vibrant mediums for social interaction and sharing of digital media. Indeed, an enormous amount of digital media generated by end users, media companies, and professional media creators is made available and shared across the Internet through web sites and uploading to various content hosting or aggregation systems and services (e.g., Flickr®, Yahoo!(r) Video, YouTube.com, etc.). End-users increasingly use or share media in a variety of on-line and interactive contexts. For example, an ever-increasing number of end-users create websites of various types, including blog pages, personalized social networking pages (such as Yahoo! 360, Facebook, or MySpace), that utilize digital media content, such as images, video, and music. Furthermore, digital media content is often found posted to online groups or forums, or other purpose-built sites, such as sites for small businesses, clubs, and special interest groups.

Such interactive systems utilize database systems to store and manage various types of information such as user account information, user profile data, addresses, preferences, and financial account information. These database systems may also store content such as digital content data objects and other media assets. For auditing, security, and other purposes, each database transaction of a database system is typically associated with a unique identifier or ticket. In connection with a given database transaction, a ticket generator issues a ticket for the transaction to allow it to be uniquely identified. A log of the transaction and its associated ticket may be stored in a database for future auditing, monitoring, or security purposes, etc.

The ticket generation process can compromise the overall performance of the database because of delay times associated with generating and assigning tickets. Such delays are inherent in the ticket generation process because tickets are typically stored in persistent storage. Persistent memory, while being very reliable, may be slow. Also, because each ticket should be unique, persistent storage needs to store a substantial number of tickets, especially in a widely-used database system such as a distributed database system that is accessed by many users.

### SUMMARY

The present invention provides a method, apparatus, and system directed to reliable and scalable ticket generation functionality. In particular implementations, the present invention provides a globally unique identifier or ticket for transactions in a database system. Rather than retrieving tickets from persistent storage, a ticket client retrieves tickets from fast random-access memory (RAM). To minimize the volatile nature of RAM storage, the system divides the available number of tickets into small chunks stored in ticket buckets, which are distributed among multiple fast cache servers. Ticket clients access the slower persistent storage to replenish the ticket buckets when a given ticket bucket becomes empty. In one implementation, the ticket buckets manage tickets using a current number (e.g., a current ticket being provided) and a maximum number (e.g., a maximum number of tickets associated with a given set of tickets in a ticket bucket). In the event of a failure, the system identifies which tickets were lost and assigns new tickets having current numbers different from those of the lost tickets, thereby increasing fault tolerance. By utilizing fast memory and minimizing the possible adverse consequences of the volatility of such fast memory, the system provides a reliable and scalable way of generating tickets.

### DESCRIPTION OF THE DRAWINGS

FIG. 1 illustrates an example network environment in which particular implementations may operate.

FIG. 2 illustrates an example computing system architecture, which may be used to implement a physical server.

FIG. 3 illustrates example logical layers which may be used to implement particular functionalities described herein.

FIG. 4 illustrates an example process flow associated with obtaining a ticket from a ticket bucket.

FIG. 5 illustrates example logical layers which may be used to initialize a ticket bucket.

### DESCRIPTION OF EXAMPLE EMBODIMENTS

### A. Example Network System Architecture

A.1. Example Network Environment

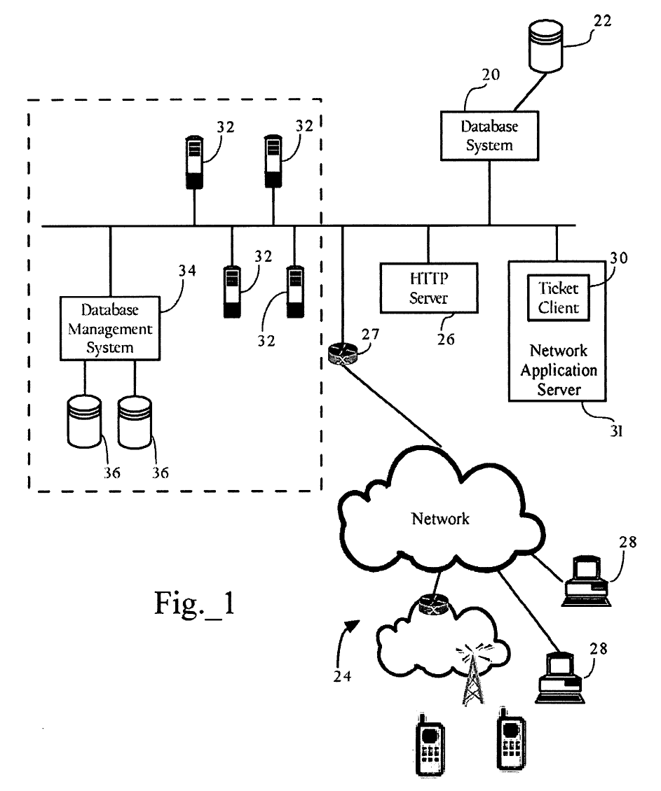

FIG. 1 illustrates an example network environment in which particular implementations may operate. As FIG. 1 illustrates, particular implementations of the invention may operate in a network environment comprising a database system 20 that is operatively coupled to a database 22 and to a network cloud 24 via a hypertext transfer protocol (HTTP) server 26 and router 27. Network cloud 24 generally represents one or more interconnected networks, over which the systems and hosts described herein can communicate. Network cloud 24 may include packet-based wide area networks (such as the Internet), private networks, wireless networks, satellite networks, cellular networks, paging networks, and the like. End-user clients 28 are operably connected to the network environment via a network service provider or any other suitable means. End-user clients 28 may include personal computers or cell phones, as well as other types of mobile devices such as lap top computers, personal digital assistants (PDAs), etc.

Database system 20 is a network addressable system that may host a database application and may operate in conjunction with a variety of network application systems, such as a social network system, etc. Database system 20 is accessible to one or more users over a computer network. In one implementation, database 22 may store various types of information such as user account information, user profile data, addresses, preferences, financial account information. Database 22 may also store content such as digital content data objects and other media assets. A content data object or a content object, in particular implementations, is an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, database 22 connotes a large class of data storage and management systems. In particular implementations, database 22 may be implemented by any suitable physical system including components, such as database servers, mass storage media, media library systems, and the like. In a particular implementation, a network application 31 may access database system 20 to retrieve, add or modify data stored therein as required to provide a network application, such as a social network application, to one or more users. In a particular implementation, network application server 31 includes a ticket client 30 that obtains ticket numbers that can be associated with individual database transactions, such as the addition or modification of database entry.

In particular implementations, the network environment includes one or more ticket clients 30 that obtain tickets for various transactions related to database system 20 or to other transactions within the network environment. In particular implementations, a ticket client 30 may be hosted on a network application server 31. As describe herein, a ticket is a globally unique identifier that can be associated with a database transaction for tracking or auditing purposes. The network environment also includes a ticket generator system comprising a database management system 34 that includes one or more persistent data stores, and one or more ticket cache nodes 32 that include cache server memories 33. Each cache server memory 33 includes reserved memory space for maintaining one or more ticket buckets. A ticket bucket is information relating to an allocation of ticket numbers stored in cache server memory 33, such as random-access memory (RAM) buffer, that stores a set of tickets available to ticket clients 30. Storing ticket information in RAM allows for fast access to tickets. Providing multiple ticket caching instances also allows for load balancing and faster access in heavy load environments.

The ticket generation system also includes a database management system 34 operatively connected to one or more persistent data stores 36. As described in more detail below, database management system 34 is operative to maintain a global current ticket number and ticket generation identifier in one or more persistent data stores, and provide an allocation of ticket numbers (referred to herein as ticket buckets) that are maintained by the ticket caching nodes 32. As described in more detail below, when a given ticket bucket runs out of tickets, the ticket client initiates a process whereby the ticket caching node 32 hosting the empty ticket bucket obtains a new set of ticket numbers. The database management system 34 stores information used to provide the tickets in the databases 36. Multiple persistent data stores 36 are used for redundancy purposes to minimize the chance of data loss. In particular implementations, the database management system 34 may be a MySQL database management system or any suitable database system.

A.2. Example Server System Architecture

The server host systems described herein (such as ticket cache nodes, network application servers, HTTP servers, and the like) may be implemented in a wide array of computing systems and architectures. The following describes example computing architectures for didactic, rather than limiting, purposes.

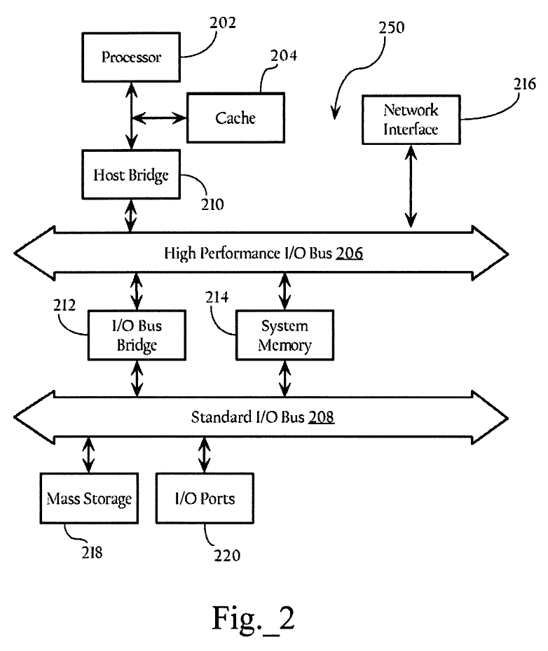

FIG. 2 illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP/Vista operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like. Of course, other implementations are possible. For example, the server functionalities described herein may be implemented by a plurality of server blades communicating over a backplane.

### B. Functional and Logical Layers

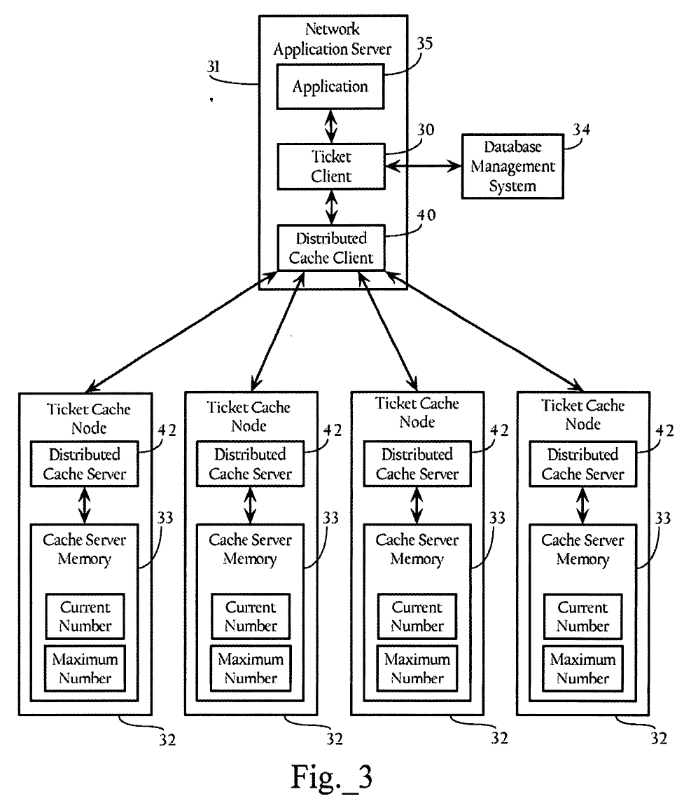

FIG. 3 illustrates example logical and functional layers which may be used to implement particular functionalities described herein. In particular implementations, when an end-user client 28 accesses network application server 31, network application server 31 (hosting network application 35) may perform one or more database transactions in connection with database system 20 (e.g., modifying information maintained by the database system 20). Network application 35, in one implementation, accesses or invokes ticket client to request ticket numbers as needed. As discussed above, the ticket client 30 may obtain a ticket number for use in uniquely identifying the database transactions. As indicated above, the ticket is associated with the transaction for tracking, auditing, or other purposes. In some implementations, the ticket may be stored in a log file, or in a reserved field of various database tables or other data structures maintained by the database system 20. In particular implementations, the ticket client 30 obtains a given ticket from a ticket bucket stored on a cache server memory 33 in a ticket cache node 32 via a distributed caching interface layer, such as a distributed memory caching system including a client layer and a server layer. In particular embodiments, the distributed memory caching system may be implemented with memcache or a memcached in-memory distributed caching system.

A distributed memory caching system speeds up dynamic database-driven websites by caching data and objects in memory to reduce the amount of data that the database reads. The distributed cache layer performs interface functions, cache management, as required by the ticket clients 30. In particular implementations, the caching layer has a distributed cache client 40 component that resides at the one or more client nodes, such as network application server 31, and a distributed cache server 42 that resides on the one or more ticket cache nodes 32. In one implementation, the distributed cache layer (implemented by the distributed cache clients 40 and distributed cache servers 42) handles tasks such as identifying the physical ticket cache node 32 that hosts a given ticket bucket and passing messages to it. Furthermore, although FIG. 3 illustrates each ticket cache node 32 hosting a single ticket bucket, the ticket cache nodes 32 may each host one to a plurality of ticket buckets in cache memory 33.

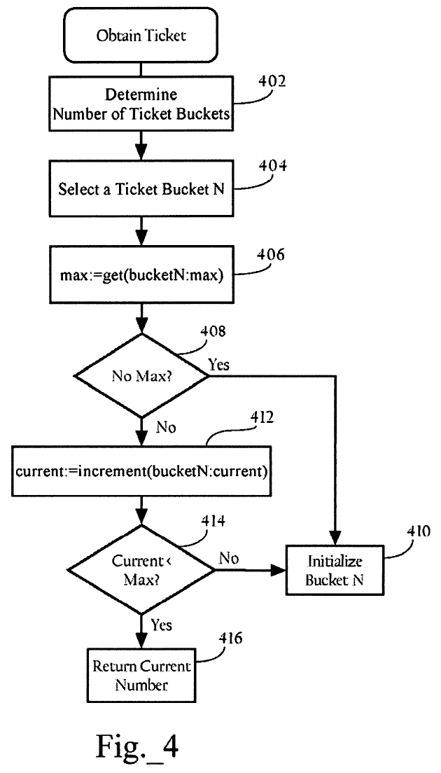

In one implementation, each ticket bucket has a ticket bucket identifier (such as a bucket number (bucket N), and stores a current ticket number and a maximum ticket number. The ticket bucket can be implemented as a simple database table or any other suitable data structure, such as a database object. In one implementation, a ticket number is a fixed-width, binary number (such as 64 bits) that has two components a generation identifier (which may be the X most significant bits) and a remaining ticket number section. In one implementation, the ticket buckets hosted by the ticket cache nodes 32 operate independently to provide tickets to various ticket clients 30. Each ticket bucket may have a different maximum number. As described in more detail below in connection with FIG. 4, each ticket bucket provides a globally unique ticket for each ticket request based on the current number and the maximum number. When a ticket client 30 receives a ticket for a given transaction, the ticket client 30 stores the ticket in a table or other suitable storage location. When a given ticket bucket is empty, the ticket client 30 communicates with the database management system 34 to refill or initiate the ticket bucket in order to replenish the ticket bucket with more tickets.

C. Obtaining a Ticket from a Ticket Bucket

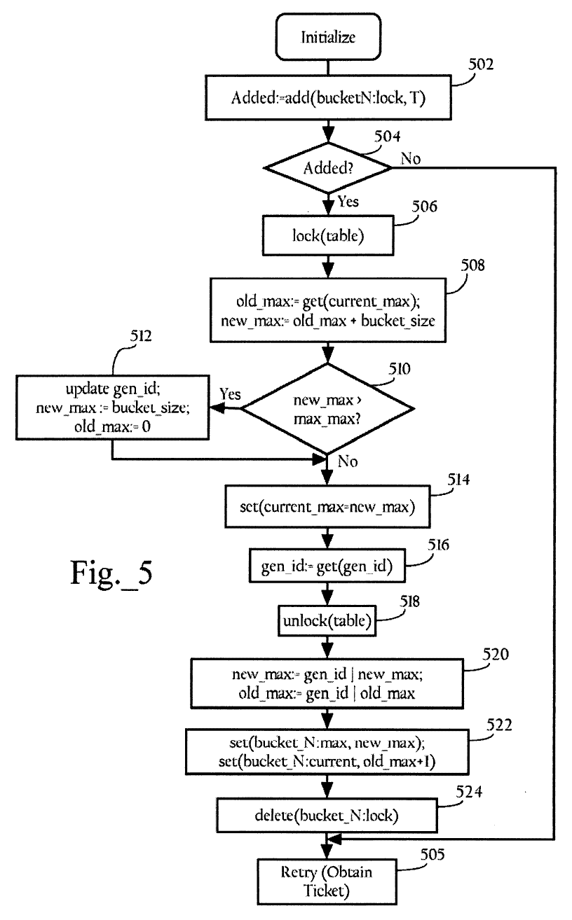

FIG. 4 illustrates an example process flow associated with obtaining a ticket from a ticket bucket, responsive to a request from a network application 35. As FIG. 4 shows, the ticket client 30 determines the number of ticket buckets (402). In one implementation, the number of ticket buckets may be preconfigured, or can be dynamically determined. The ticket client 30 then selects a ticket bucket N (404). In one implementation, the selection may be a random selection. In one implementation, the selection may be pursuant to some ordering scheme (e.g., round robin order or other suitable ordering scheme). The ticket client 30 then reads the bucket data from the ticket bucket N. In particular implementations, the ticket client 30 reads the ticket bucket data by passing a command to the distributed cache client 40, which accesses the distributed cache server 42 associated with the ticket cache node 32 that hosts the selected ticket bucket to execute commands, such as get commands. In one implementation, the distributed cache server 42 determines the cache server memory 33 that hosts the requested ticket bucket N and reads that cache server memory 33. As indicated above, the bucket data includes two components, a current ticket number and a maximum ticket number. In one implementation, the current number is the current ticket number that was last given out and associated with a previous transaction. The maximum number is a predefined maximum number of tickets to be given out for a particular set of tickets for a given ticket bucket. In one implementation, the ticket client 30 issues a get command to read the maximum number stored in the selected ticket bucket (bucket N) (406). In one implementation, if there is no maximum number assigned to the ticket bucket N (408), the ticket client 30 initializes the ticket bucket N (410) (see FIG. 5, below). As described in more detail below in connection with FIG. 5, the ticket client 30 may access database management system 34 to initialize the ticket bucket N.

In one implementation, if there is a maximum number, the ticket client 30 causes the distributed cache server 42 to return a current number to the ticket client 30. In one implementation, the ticket client 30 passes an increment command (412) that increments the current number of bucket N by 1. In one implementation, the increment operation is atomic to prevent other processes from incrementing the current number before the instant increment operation is completed. The distributed cache server 42, responsive to the increment command, causes the cache server memory 33 to store the new incremented current number. As tickets are issued from the ticket bucket, the current number increases towards the maximum number. For example, the first ticket bucket may start with a current number of 0 and a maximum number of 10,000 (omitting consideration of the generation identifier). After the first ticket 0 is given out, the current number increments to 1. After ticket 1 is given out, the current number increments to 2, and so on up to ticket 10,000. If the ticket client 30 determines that the current number is less than the maximum number (414), the ticket client 30 returns the current number to the network application 35 (416). In one implementation, if the current number equals or is greater than the maximum number, the ticket client initializes the ticket bucket N (410). For example, continuing with the previous example, when ticket 9,999 is given out, the current number on the next access increments to 10,000. At this point, the current number returned to the ticket client 30 equals the maximum number. In other words, ticket 9,999 is the last ticket of this particular ticket bucket to be given out until the ticket bucket is re-initialized.

### D. Initializing a Ticket Bucket

FIG. 5 illustrates an example process flow associated with initializing a ticket bucket. The ticket client 30 first attempts to obtain a lock on the ticket bucket. In one implementation, the ticket client locks the ticket bucket by instructing the distributed cache server 42 to execute an add operation including a lock command (502), which in effect results in a software lock. In one implementation, the lock on a ticket bucket expires after a predefined time period (e.g., 15 seconds). If another ticket client 30 already has a lock on the ticket bucket (bucket N), the add operation fails (504), which indicates that another ticket client 30 has started to re-initialize the ticket bucket. In this case, the ticket client 30 retries the obtain ticket process described in connection with FIG. 4, which may result in selection of the same ticket bucket or a different ticket bucket. In one implementation, the ticket client 30 may retry (505) after a predefined time period (e.g., 50 ms). In one implementation, the predefined time period for retries may become increasingly longer with each retry.

If the add operation is successful, the ticket client 30 knows it has a lock on the ticket bucket, and accesses the database management system 34 to lock a table that stores a current global maximum ticket number and a current generation ID (506). In one implementation, the current maximum number is the maximum number of the most recently initialized ticket bucket, and the generation ID is a number that is used for recovery purposes in the event of a catastrophic failure. During this lock operation, no other ticket client 30 may access the database for other ticket buckets in order to prevent two ticket buckets from being assigned the same set of ticket numbers.

In one implementation, the generation ID is added through a logical OR operation with a current ticket number to create a given ticket. The generation ID may start at a 0 value before any catastrophic failures and is then incremented (e.g., by a value of 1) after each catastrophic event. The generation ID is incremented because it may be unclear as to which tickets containing the old generation ID have been lost during the failure. Because the generation ID is a portion of the total ticket number, incrementing the generation ID ensures that the next set of tickets given out will have unique numbers. In particular implementations, the most recent generation ID used may be ascertained by looking at the X (e.g., 16) most significant bits of the most recently assigned tickets. In one implementation, when the generation ID is incremented, the current maximum number is set to zero. In particular implementations, the generation ID may be set manually. Thereafter, the maximum number is incremented as ticket clients 30 re-initialize the ticket buckets.

In one implementation, the table containing the current global maximum ticket number and the current generation ID may be stored on two physically separate databases. This redundancy ensures reliability, as there is a low probability of failure of both databases. In particular implementations, the MySQL layer includes processes for backing up the table in the databases in a redundant manner.

Returning to FIG. 5, the ticket client 30, after locking the table (506), obtains a set of ticket numbers based on the bucket size of bucket N. The variables old_max and new_max are temporary variables used by the ticket client 30 when re-initializing a ticket bucket. As described above, the current global maximum ticket number (current_max) is the maximum number of the most recently initialized ticket bucket. In one implementation, the maximum number may be any predefined number up to 2^{y}−1, where Y equals the bit width of the ticket number less the bit width (X) of the generation ID. For example, if the total bit width of the ticket number is 64 and the generation ID is 16 bits, Y equals 48. As illustrated in FIG. 5, the ticket client 30, to re-initialize the bucket, sets old_max to the current global maximum number, and sets new_max by adding a bucket size value to old_max (508). In particular implementations, the ticket bucket size may vary for each ticket bucket. In one implementation, the ticket bucket size may adjust dynamically. For example, if ticket bucket are being initialized too frequently (e.g., every 5 seconds), the ticket client 30 (or some other process) may increase the ticket bucket size to an appropriate value such that the ticket buckets are initialized less frequently (e.g., every hour).

In one implementation, if the new maximum number is greater than a predefined maximum threshold (e.g., 2^{y}−1) (510), the ticket client 30 may then update the generation ID (512). In one implementation, the ticket client 30 increments the generation ID by one, sets new_max equal to the ticket bucket size, and sets the old_max to 0.

In one implementation, the ticket client 30 sets the current global maximum number maintained by database management system 34 to new_max (514). In one implementation, the ticket client 30 retrieves the current generation ID value (516), and unlocks the table (518). The ticket client 30 then concatenates the generation ID and the old and new current maximum numbers (520). In one implementation, the ticket client 30 may set the new maximum number (new_max) to the generation ID logically ORed with the new maximum number, and sets the old maximum number (old_max) to the generation ID logically ORed with the old maximum number (520). In particular implementations, the ticket client 30 then accesses ticket cache node 32 hosting ticket bucket N, and sets the maximum number of the ticket bucket to the new (updated) maximum number (new_max), and the current number of the ticket bucket to the old maximum number (old_max) (522). In one implementation, the distributed cache server 42 may add 1 to old_max to ensure uniqueness. The ticket client 30 then unlocks the ticket bucket (524). In one implementation, the ticket client 30 may unlock the ticket bucket by instructing the distributed caching layer to delete the lock on the ticket bucket. The ticket client 30 may then retry the process of obtaining a ticket, as discussed in connection with FIG. 4.

In particular implementations, a catastrophic failure of a ticket cache node 32 may result in a loss of a bucket of tickets. The tickets given out prior to the failure are nevertheless valid and unique identifiers. Given that tickets are assigned in buckets to the ticket cache servers 32 and the global current numbers are stored persistently in database management system 34, the remaining tickets allocated in a given bucket are essentially skipped over in the sequence number space. Furthermore, when a ticket cache node 32 fails, the ticket client 30 may access other ticket cache nodes 32 maintaining other ticket buckets. In addition, if the failed ticket cache node 32 recovers it may obtain another bucket of tickets, when a ticket client 30 selects the bucket(s) it hosts, determines that it has no maximum, and causes it to re-initialize (see FIG. 4). In this manner, scalable access to ticket numbers is facilitated, given that the ticket cache nodes 32 can be readily replicated. The impact of a failure of a given ticket cache node 32 on the sequence number space, however, is limited to the bucket size of the ticket bucket(s) hosted on the failed node.

Still further, if there is a catastrophic failure of database management system 34, the generation identifier can be incremented and the entire ticket generation system re-initialized. The current generation identifier upon failure can be ascertained by inspecting the database system 20, for example, for the most recent transaction identifiers. The generation identifier can then be incremented to a new number. In this manner, global uniqueness of ticket numbers is ensured.

In one implementation, the process of refilling the ticket bucket may be fast enough such that a given ticket bucket is refilled before another request is made for a ticket from that particular ticket bucket. In one implementation, if a given ticket client 30 requests another ticket from the ticket bucket before it is fully re-initialized, the distributed caching layer notifies the ticket client 30 that the ticket bucket is full. The ticket client may then wait for a predefined time period and retry, or may select another ticket bucket. In one implementation, to minimize delays, the ticket client 30 may give out another ticket greater than maximum number. For example, the ticket client 30 may give out ticket 10,000 when the maximum number is 10,000. In this scenario, when the ticket client 30 refills that ticket bucket, the ticket client 30 would start the current number at 10,001 or 10,002 in order to provide globally unique tickets.

The present invention has been explained with reference to specific embodiments. For example, while embodiments of the present invention have been described as operating in connection with memcache and MySQL, the present invention can be used in connection with any suitable protocol environment. Other embodiments will be evident to those of ordinary skill in the art. It is therefore not intended that the present invention be limited, except as indicated by the appended claims.

What is claimed is:

1. A ticket generator comprising:
a persistent data store comprising a current generation identifier and a global current maximum ticket number;
a plurality of cache servers, each operative to maintain, in a memory cache, one or more ticket buckets, each ticket bucket comprising a current ticket number and a maximum ticket number;
one or more ticket clients operative to:
select, responsive to a request, a ticket bucket;
obtain a ticket number based on the current ticket number of the selected ticket bucket and the current generation identifier; and
conditionally reset the current and maximum ticket numbers of the selected ticket bucket, if the ticket number exceeds a maximum ticket number of the selected bucket; else, return the ticket number in response to the request.

2. The ticket generator of claim 1 wherein the one or more ticket clients are operative to return the ticket number in response to the request if the ticket number does not exceed a maximum ticket number of the selected bucket.

3. The ticket generator of claim 1 wherein the one or more ticket clients are operative to lock a persistent memory when resetting the current and maximum ticket numbers of the selected ticket bucket.

4. The ticket generator of claim 1 wherein the one or more ticket clients are operative to lock a persistent memory, using an add operation, when resetting the current and maximum ticket numbers of the selected ticket bucket.

5. The ticket generator of claim 1 wherein the current ticket number comprises the current generation identifier, wherein the current generation identifier is utilized during a failure event, and wherein the generation identifier is incremented by a value of at least one after the failure event.

6. The ticket generator of claim 1 wherein the ticket bucket selecting is random.

7. The ticket generator of claim 1 wherein the ticket bucket selecting is pursuant to an ordered scheme.

8. The ticket generator of claim 1 wherein the one or more ticket clients are operative to obtain the ticket number via a caching interface layer such as a distributed memory caching system.

9. The ticket generator of claim 1 wherein the one or more ticket clients are operative to obtain the ticket number via a distributed cache client of an in-memory distributed caching system.

10. The ticket generator of claim 1 wherein the one or more ticket clients are operative to add the generation identifier through a logical OR operation with a current ticket number to create a given ticket.

11. The ticket generator of claim 1 wherein the generation identifier starts at an initial value before any catastrophic failures and is then incremented by a predefined incremental value after a catastrophic event.

12. A method comprising:
maintaining a persistent data store comprising a current generation identifier and a global current maximum ticket number;
selecting, responsive to a request, a ticket bucket hosted in a cache, wherein the ticket bucket comprises a current ticket number and a maximum ticket number;
obtaining a ticket number based on the current ticket number of the selected ticket bucket and the current generation identifier;
conditionally resetting the current and maximum ticket numbers of the selected ticket bucket, if the ticket number exceeds a maximum ticket number of the selected bucket; and
returning the ticket number in response to the request if the ticket number does not exceed a maximum ticket number of the selected bucket.

13. The method of claim 12 further comprising locking a persistent memory when resetting the current and maximum ticket numbers of the selected ticket bucket.

14. The method of claim 12 wherein the current ticket number comprises the current generation identifier, wherein the current generation identifier is utilized during a failure event, and wherein the generation identifier is incremented by a value of at least one after the failure event.

15. The method of claim 12 wherein the ticket bucket selecting is random.

16. The method of claim 12 wherein the ticket bucket selecting is pursuant to an ordered scheme.

17. The method of claim 12 further comprising obtaining the ticket number via a caching interface layer such as a distributed memory caching system.

18. The method of claim 12 further comprising obtaining the ticket number via a distributed cache client of an in-memory distributed caching system.

19. The method of claim 12 further comprising adding the generation identifier through a logical OR operation with a current ticket number to create a given ticket.

20. The method of claim 12 wherein the generation identifier starts at an initial value before any catastrophic failures and is then incremented by a predefined incremental value after a catastrophic event.
